(19) United States
(12) Patent Application Publication
(10) Pub. No.: US 2016/0318161 A1
(43) Pub. Date: Nov. 3, 2016

(54) TOOL FOR THE REMOVAL AND INSTALLATION OF POLAR END CAPS OF FRESHWATER TANKS ON BOARD AIRPLANES IN THE BUILT-IN STATE

(71) Applicant: Airbus Operations GmbH, Hamburg (DE)

(72) Inventor: Henning J. JOEST, Hamburg (DE)

(21) Appl. No.: 15/141,224

(22) Filed: Apr. 28, 2016

(30) Foreign Application Priority Data
Apr. 29, 2015 (DE) 10 2015 106 679.3

(51) Int. Cl. B25B 13/50; B25B 13/48; B64D 11/00; B25B 13/46; B25B 23/14; B67B 7/18; B25B 27/00

(52) U.S. Cl. CPC B25B 13/50; B67B 7/18; B25B 13/481; B25B 27/0028; B25B 13/46; B25B 23/14; B64D 11/0007

(57) ABSTRACT

This relates to a tool for removing and installing polar caps of freshwater tanks on board airplanes without first removing or displacing the tanks or a compartment. The tool encompasses a key disk, a coupling and a lever. One end of the lever is joined in a torque-proof manner with the key disk via the coupling. The key disk can be joined in a torque-proof manner with the end cap, and the other end of the lever exhibits a key connection that is set up to be joined with a torque wrench. The length of the lever is here dimensioned and the key connection is designed in such a way that obstacles in the environment of the polar end caps do not block the tool while it is in use.

### CROSS-REFERENCE TO RELATED APPLICATION

This application claims priority to German Patent Application No. 10 2015 106 679.3, filed Apr. 29, 2015, which is incorporated herein by reference in its entirety.

### TECHNICAL FIELD

The embodiments described herein relate to a tool for the removal and installation of polar end caps (PEC's) of freshwater tanks on board airplanes, wherein the freshwater tanks remain positioned at their designated locations inside the airplane, and also need not be displaced. PEC's are usually screwed in at both end sides of the freshwater tank, and seal the freshwater tank in conjunction with an O-ring. A distinction is made between the outer PEC's, which face the outer skin of the airplane, and the inner PEC's, which are usually spaced less than 10 cm apart from an adjoining compartment inside of the vehicle.

Leaks on the O-rings of the PEC's require that the O-rings are replaced, for which it becomes necessary to repair the respective freshwater tank during a maintenance event at an airline or airplane manufacturer, since defective O-rings of the freshwater tanks of the airplane result in that the airplane may no longer be utilized over long ranges. In such a case, not enough freshwater is available.

The freshwater tanks are usually accommodated in airplanes so as to maximally economize on space, leaving only very little space available for tools with which to change out the PEC. Previously known tools and repair methods require the removal or at least a displacement of the freshwater tank, which is very time-consuming and expensive. In addition, freshwater tanks in airplanes are usually situated in the area of the so-called “lower deck-cabin crew rest compartment” (LD-CCRC). These LD-CCRC's are usually located in the rear cargo sector of the airplane. In this position, the LD-CCRC blocks or at least hampers access to the freshwater tanks also situated there. If one of these water tanks has to be removed from the mentioned area, then the LD-CCRC must often also be at least partially removed and reinstalled. There are customer versions of airplanes in which no LD-CCRC is built in, wherein a cargo hold with easily removable paneling, and hence easy access to the inner PEC's, is provided instead. In these cases, while there is smooth access to the inner PEC's, a great deal of effort is still involved in accessing the outer PEC's, involving the removal of the tanks for PEC repair.

Therefore, the object of the embodiment may be seen in providing a tool of the kind mentioned at the outset that is better tailored to the tight space available for replacing a PEC described above, so that the respective freshwater tank and potentially a LD-CCRC need no longer be removed, thus allowing for a major savings of time and money.

The tool according to the embodiments described herein in encompasses a key disk, a coupling and a lever. The tool is preferably made essentially out of an aluminum material. One end of the lever is joined in a torque-proof manner with the key disk via the coupling. The key disk can be joined in a torque-proof manner with the end cap, and the other end of the lever exhibits a key connection, which is set up to be joined with a torque wrench or a ratchet. The length of the lever is here dimensioned and the key connection is designed in such a way that obstacles around the PEC do not block the tool during its use. This enables a PEC repair directly inside the airplane without having to remove the respective tank beforehand. The tool according to the embodiment and the torque wrench or the ratchet constitute a system for replacing the PEC's.

The key disk can be placed directly against the PEC to be replaced, and is set up to be joined in a torque-proof manner with the PEC, so that the latter can be turned in the opening direction (for detaching and removing the PEC from the water tank) or in the closing direction (for joining the PEC to the water tank). One end of the lever is joined with the key disk, wherein this connection is preferably easily detachable in design. The other end of the lever can be connected with a torque wrench or a ratchet on an appropriately configured key connection, e.g., on a ½ inch plug connection, so that a prescribed torque can be introduced into the PEC via the lever, the coupling and the key disk. As a consequence, the torque wrench does not rest directly against the PEC, but is instead spaced apart from the latter on that end of the lever facing away from the PEC. Suitably dimensioning and shaping the lever and key connection here allows the lever and torque wrench to avoid contact with neighboring elements of the airplane when using the tool according to the embodiment. It is this special shape that allows the tool to move, and enables PEC repair with the tank built in.

In other words, the tool according to the embodiment eliminates the necessity of securing the torque wrench directly to the key disk, so that it can be spaced apart from the latter so as to avoid blockage by obstacles, e.g., in the form of structural parts of the airplane, such as the frame or stringers, in the immediate environment of the PEC. The advantage to this is that the PEC or its O-ring can be replaced on site inside of the airplane, without the freshwater tank and LD-CCRC having to be removed. This enables a significant economization of time and costs. In addition, the tool according to the embodiment can exhibit a particular flat structure, in particular in the area of the key disk.

The very flat structure in the area of the key disk and its coupling makes the tool suitable not just for the PEC's on the outside which are otherwise impossible to maintain, but also for the PEC's on the inside of the tank which are very difficult to access. The inner PEC's only exhibit a free space of about 10 cm with the LD-CCRC built in, wherein about 50% of this space is additionally filled with insulation material.

In an advantageous embodiment of the tool, the key connection for a torque wrench or a ratchet exhibits an offset. This makes it possible to circumvent obstacles in the pivoting area of the torque wrench by having the offset displace the pivoting area of the torque wrench outside the area of the obstacles.

In addition, the key connection can advantageously be designed with a continuous opening, so that a torque wrench or a ratchet can be joined with the tool from two opposite sides. This makes it possible to use the tool in an especially flexible manner, and to adjust it to the varying installation positions of the tank and accompanying PEC. Furthermore, the continuous opening in conjunction with a plug attachment of the torque wrench or the ratchet makes it possible to provide the offset described above. Moreover, insertion from the side facing the tank prevents the key disk from potentially being lifted out of the PEC, since no longer any bending moment is present, i.e., the key disk is situated at the same height as the inserted torque wrench. This virtually eliminates the need for guiding the key disk with a second hand during the loosening or tightening process.

In an embodiment, it is advantageously possible to set up the key connection to be joined with the torque wrench at an angle of 0° or 90°. This makes the tool especially flexible to use with a 90° offset, at which a torque set with the torque wrench can be conveyed to the PEC without any further conversion. Apart from that, other angles can also be realized, although this would unnecessarily complicate torque conversion.

At an offset of 0°, where the effective lever arm consists of the length of the lever of the tool and the added length of the torque wrench, and hence becomes larger, the process must take place with a reduced adjusted torque. However, the user can determine this value through simple calculation. Given the lengthened lifting and improved accessibility as a function of the respective PEC position, the user in this case has to apply less manual force, which is advantageous in the confined conditions inside of the airplane structure.

The key disk can further be advantageously set up to be positively joined in a torque-proof manner with the end caps, e.g., by means of recesses in the key disk, into which corresponding counter-elements of the PEC engage.

Such a connection is characterized by its particular simplicity, and also permits a particular safe and precise alignment of the key disk on the PEC.

In this conjunction, it is especially advantageously provided that the edge side of the key disk exhibits at least eight equidistant recesses, which can be made to engage with elements protruding from the end cap. In other words, in 45° increments in the circumferential direction, a respective element, e.g., a pin, of the PEC fits into a recess, e.g., extending from the edge of the key disk toward the center of the key disk. As a result, the key disk can be especially flexibly aligned relative to the PEC, which facilitates use under confined conditions. The number of equidistant recesses can be further increased to enhance flexibility.

Furthermore, the key disk can advantageously exhibit the same radius as the contact surface of a circular PEC, which in particular enables an especially advantageous torque transfer from the key disk to the PEC.

In addition, the lever, the coupling and the key disk can exhibit boreholes that are aligned with each other, so that a safety bolt can be inserted into the aligning boreholes of the lever in order to captively secure the lever to the key disk while handling the tool. This further generates a particularly strong and durable, torque-proof connection, which has an especially advantageous effect on tool reliability. Furthermore, the lever can be very easily detached from the coupling, and hence from the key disk, by removing the safety bolt.

Another advantageous embodiment provides that the coupling is joined in a torque-proof manner to the key disk via three retaining bolts, and that the lever exhibits a plug attachment for a torque-proof connection with the key disk. In this way, the lever can be inserted into the coupling and thereby be joined in a torque-proof manner with the key disk, enabling the tool to exhibit a particular flat configuration, in particular in the area of the key disk. The benefit is that the tool can be used in particular in the area of the inner PEC's described further above. In addition, it is advantageously also provided that the unit comprised of the key disk and coupling is designed as a one-part component, thus eliminating the need for attachment with the three retaining bolts.

A further embodiment of a tool encompasses a key disk and a coupling, wherein the coupling is joined in a torque-proof manner with the key disk, and the coupling exhibits a receptacle, which is designed in such a way that an insert of a torque wrench can be positively introduced into the latter. This configuration also describes the use of the PEC tool, but without the lever. This may be advantageous depending on accessibility and position.

### BRIEF DESCRIPTION OF THE DRAWINGS

The various embodiments will hereinafter be described in conjunction with the following drawing figures, wherein like numerals denote like elements, and:

FIG. 1 is a schematic view of an exemplary embodiment of a known tool;

FIG. 2 is a schematic view of an exemplary embodiment of a tool according to an embodiment with an alternative offset;

FIG. 3 is a perspective exploded view of the tool according to FIG. 2 with mounted coupling and a lever, which can be fastened;

FIG. 4 is the tool of FIG. 3 with dismantled coupling and no lever;

FIG. 5 is the tool of FIG. 3 with the lever fastened;

FIG. 6 shows a torque wrench inserted into the insert of the lever according to FIG. 5 at a 0° offset; and

FIG. 7 is a torque wrench inserted into the insert of the lever according to FIG. 5 at a 90° offset.

### DETAILED DESCRIPTION

The following detailed description is merely exemplary in nature and is not intended to limit the disclosed embodiments or the application and uses thereof. Furthermore, there is no intention to be bound by any theory presented in the preceding background

### DETAILED DESCRIPTION

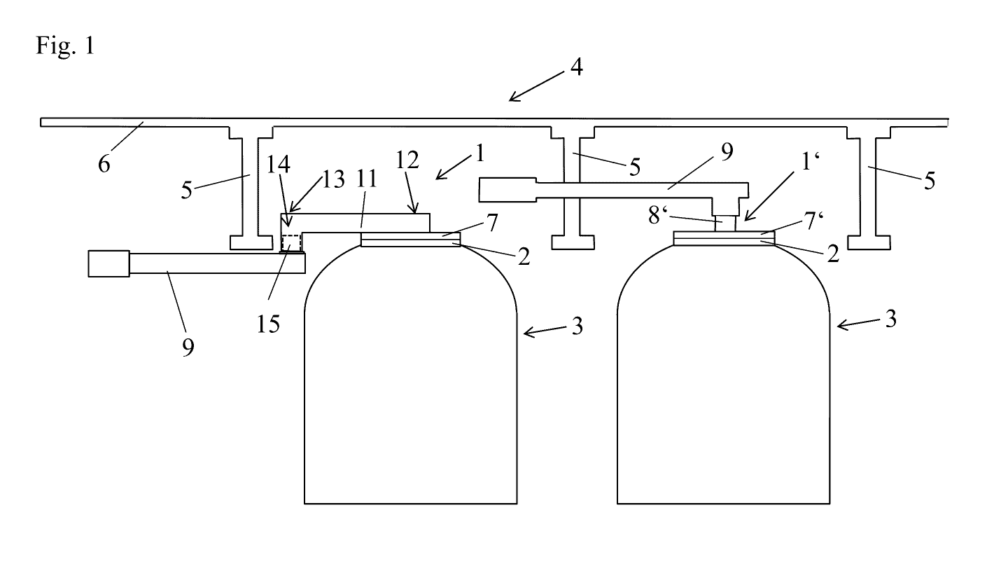

FIG. 1 shows a schematic comparison of an exemplary embodiment of a tool according to an embodiment 1 (left side of FIG. 1) and a known tool 1′ (right side of FIG. 1). The tools are for fastening and loosening polar end caps (PEC) 2, outer PEC's in the example depicted, of two freshwater tanks 3 on board an airplane 4. The respective freshwater tanks 3 are also closed off at the outer end with PEC's 2, and each sealed by means of an O-ring (not shown). FIG. 1 exemplarily depicts three frames 5 and an outer skin 6 of the airplane 4. The frames 5 are located in the immediate environment of the outer PEC's 2.

The known tool 1′ shown on the right side of FIG. 1 encompasses a key disk 7′, which was detachably joined in a torque-proof manner with the PEC 2 of the right tank 3 so as to detach the PEC 2 from the tank 3. The key disk 7′ exhibits a plug attachment 8′, which centrally protrudes perpendicular from the side of the key disk 7′ facing away from the PEC 2, and is joined in a torque-proof manner with the key disk 7′. The plug attachment 8′ builds up the known conventional tool 1′ so high that it cannot be used for changing out the outer PEC's with the tank built in for lack of free accessibility to the frames.

Even with respect to the inner PEC's (not shown), limitations are also placed on the conventional tool, since it cannot be used in all cases. With the LD-CCRC built in, there is a distance of at most 10 cm between the inner PEC's and outer wall of the LD-CCRC, wherein up to 50% of this gap is filled with insulation material, which impedes handling and visibility.

Detachably inserted onto the plug attachment 8′ is a torque wrench 9 with a socket, with which a torque could be transferred to the plug attachment 8′, the key disk 7′ and hence also the PEC 2, so that the PEC 2 could be fastened to the tank 3 and detached therefrom. However, the frames 5 depicted in the center right or outer right in FIG. 1 pose obstacles to actuating the torque wrench 9, wherein the frames 5 make it impossible to use the tool 1′ as described above. When turning the torque wrench 9, the latter would collide with the frames 5. For this reason, the tanks are removed for repairing an outer PEC, and repaired at a workshop; however, this also requires that a suitable clamping be established to prevent the tank from twisting.

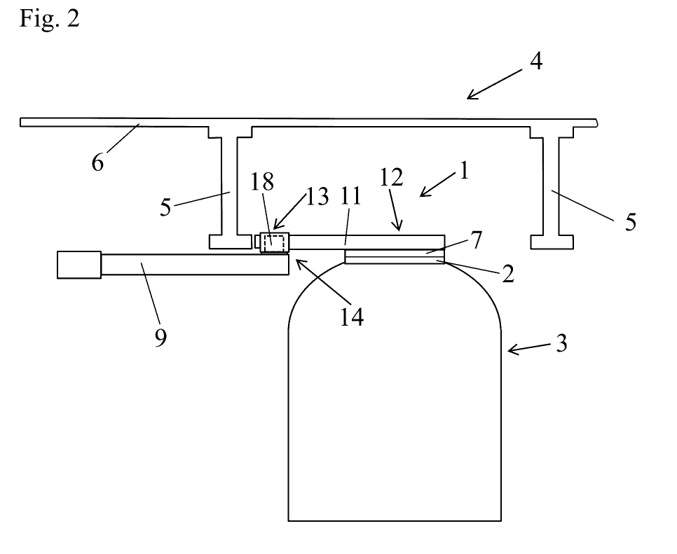

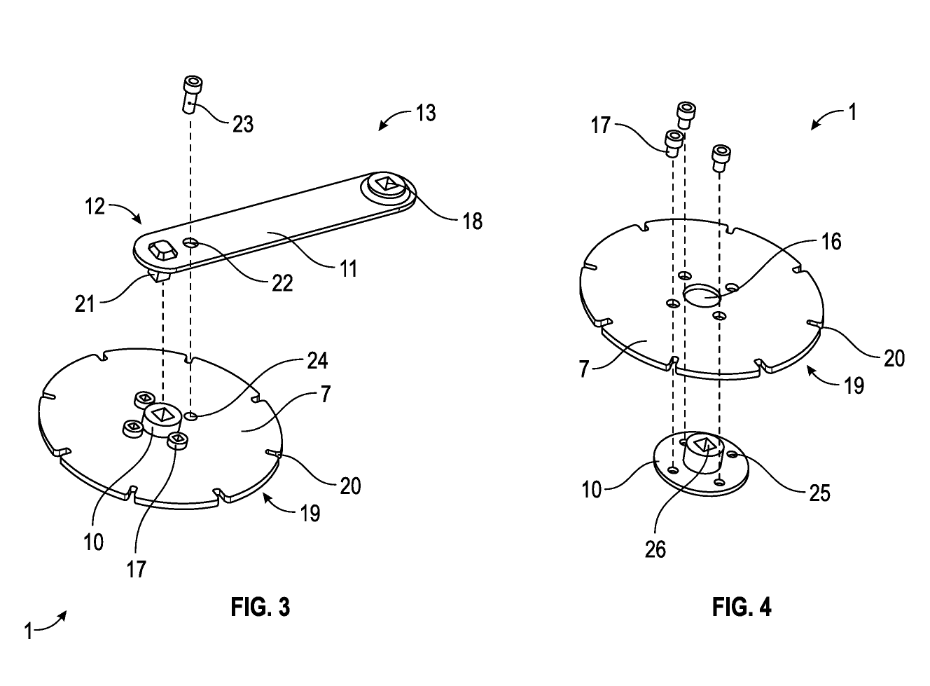

The tool 1 according to an embodiment shown on the left of FIG. 1 is made out of an aluminum material, and comprises a key disk 7, which is detachably joined in a torque-proof manner with the outer PEC 2 of the left tank 3 via insertion, so as to detach the PEC 2 from the tank. In addition, the tool 1 comprises a coupling not shown on FIG. 1, which corresponds to the coupling 10 depicted in FIGS. 3 to 5, as well as a lever 11. The key disk 7 is joined in a torque-proof manner with the coupling, and an end 12 of the lever 11 depicted on the right in FIG. 1 on the left side is joined in a torque-proof manner with the coupling (see FIG. 2). Another end 13 of the lever 11 depicted on the left in FIG. 1 exhibits an offset 14, which with the tool 1 in an inserted state protrudes essentially perpendicular from the remaining lever 11, and is directed toward the tank 3.

According to FIG. 1, the offset 14 exhibits an insert 15 (shown with a dashed line in FIG. 1), wherein a torque wrench 9 with a ½ inch plug attachment is inserted into the insert 15.

According to an exemplary embodiment shown in FIG. 2, the offset 14 is achieved by virtue of the fact that the open end 13 of the lever 11 depicted on the left of FIG. 2 exhibits a key connection in the form of a continuous insert 18, into which the torque wrench 9 with a conventional ½ inch plug attachment is inserted from the side of the lever 11 facing the freshwater tank 3. In this case, the offset is formed by the insert 18 of the lever and the plug attachment of the torque wrench 9.

The length of the lever 11 is dimensioned in such a way in FIG. 1 and FIG. 2 that it can be turned between the frames 5 depicted in the middle and on the left without colliding with these frames 5. The respective offset 14 is long enough to prevent the plug attachment 15 from extending between the frames 5 with the tool 1 inserted. The pivoting range of the torque wrench 9 is thus displaced further in the direction of the interior of the aircraft 4, so that the pivoting range extends outside the area of the frames 5. This makes it possible to join the torque wrench 9 in a torque-proof manner with the plug attachment 15 and turn it without touching the frames 5 or some other surrounding structure, i.e., the frames 5 do not impede the tool 1 while it is in use.

FIGS. 3 to 5 show the structural design of the tool 1 according to FIG. 2. The tool 1 encompasses the key disk 7, the coupling 10 as well as the lever 11. The coupling 10 is inserted through a central, circular opening 16 of the key disk 7 and joined in a torque-proof manner with the key disk 7 via three bolts 17, wherein only one of the bolts 17 is labeled with a reference number for the sake of improved clarity. Only three fastening bolts 17 are depicted on FIG. 3. This does not constitute negligence, but rather signals that only these three bolts permanently establish the fixed bond between the key disk and coupling. A safety bolt 23 shown on FIG. 3 serves to captively secure the lever 11 to the coupling and key disk 7, and is loosened depending on the configuration to remove the lever 11 (FIG. 4). However, the safety bolt 23 is not required for using the tool 1 without the lever 11.

The end of the lever 11 shown on the left of FIG. 3 exhibits a plug attachment 21, which is inserted into the coupling 10 in order to establish a torque-proof connection with the coupling 10, and thereby with the key disk 7. In addition, the lever 11 exhibits a borehole 22 through which the safety bolt 23 can be inserted to captively secure the lever 11 to the key disk 7 and the coupling by inserting the safety bolt 23 through a borehole 24 of the key disk 7 aligned with the borehole 22 of the lever 11. Finally, the coupling also exhibits another borehole 25 (FIG. 3), which aligns with the borehole 22 of the lever 11 and with the borehole 24 of the key disk 7. The safety bolt 23 is inserted through the mentioned three boreholes 22, 24, 25, and thus establishes a captive, torque-proof connection between the lever 11, the coupling 10 and the key disk 7. Removing the safety bolt makes it very easy to detach the lever 11 from the coupling 10, and hence from the key disk 7. The coupling 10 here only protrudes from the key disk surface to which the lever 11 is secured by a distance that enables an easy replacement of the inner PEC's described further above by means of the tool 1 according to the embodiment, since a great deal of free space now remains between the inner PEC and outer wall for handling purposes.

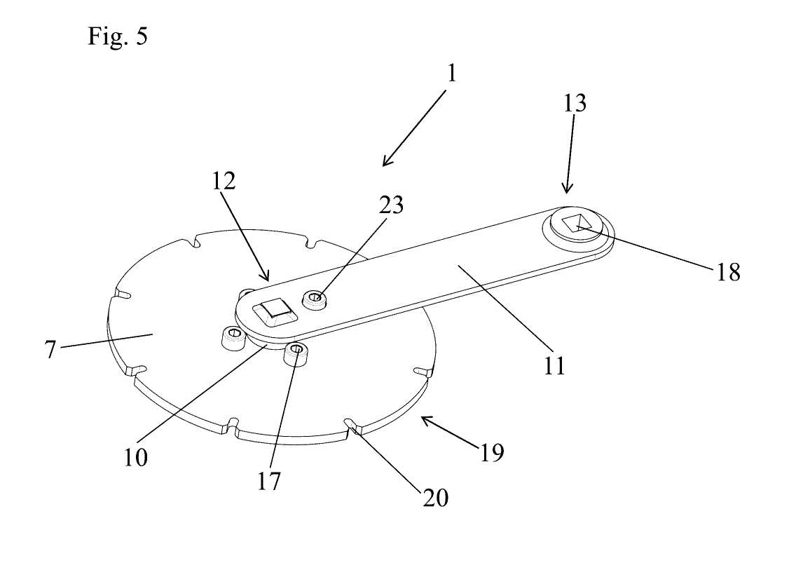

The open end 13 of the lever 11 shown on the right of FIG. 3 exhibits a key connection in the form of an insert 18, into which a torque wrench (not shown in FIG. 3 or 5) with a conventional ½ inch plug attachment can be inserted from the upper and lower side of the lever 11.

The edge 19 of the key disk 7 exhibits a total of eight recesses 20, which are each spaced apart from each other in the circumferential direction by 45°. Only one of the eight recesses 20 is labeled with a reference number for the sake of improved clarity. The recesses 20 are dimensioned and positioned in such a way that protruding shapes of a PEC (not shown) with the same radius as the key disk 7 can engage into them, making it possible to establish a positive, torque-proof connection between the key disk 7 and the PEC.

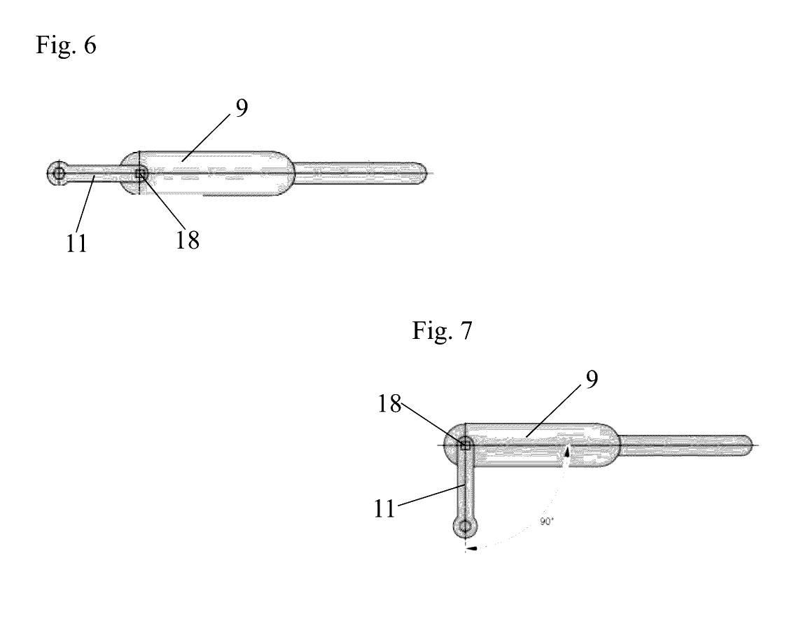

FIGS. 6 and 7 show the torque wrench 9 inserted into the insert 18 in two different orientations. In particular, the torque wrench 9 can be connected to the insert 18 in such a way that the torque wrench runs in the same direction as the lever (0° offset, FIG. 6) or perpendicular to the lever (90° offset, FIG. 7). Depending on how the obstacles are arranged in the environment of the PEC, an offset suitable for this purpose can thereby be established. Given a configuration with a 0° offset (FIG. 6), the torque set on the torque wrench 9 must be adjusted to the torque that is always identical for the PEC (reduction is required by lengthening the effective lever).

The tool 1 shown in FIG. 4 represents another advantageous configuration of the tool 1 according to an embodiment, which encompasses the key disk 7 and the coupling 10, wherein the coupling is joined in a torque-proof manner with the key disk 7 via three bolts 17. A plug attachment of a torque wrench (not shown) can be positively inserted directly into a receptacle 26 of the coupling with a matching design. As a result, the tool is especially flat in design, and particularly suitable for replacing the inner and outer PEC with the tank built in. Let it be noted that the new tool according to the embodiment can of course also be used to effect repairs at a workshop and without any impeding surrounding structures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A tool for fastening and detaching an end cap of a water tank of an airplane, comprising:
a key disk,
a coupling, and
a lever, having first and second ends, wherein
the first end of the lever is joined in a torque-proof manner with the key disk via the coupling;
the key disk can be joined in a torque-proof manner with the end cap;
the second end of the lever exhibits a key connection that can be joined with a torque wrench, and
the length of the lever is dimensioned in such a way and the key connection is designed in such a way that the tool is not blocked by obstacles in the environment of the end cap while in use.

2. The tool according to claim 1, wherein the key connection exhibits an offset.

3. The tool according to claim 1, wherein the key connection exhibits a continuous opening, and is set up to be joined with the torque wrench from two opposite sides.

4. The tool according to claim 1, wherein the key connection is set up to be joined with the torque wrench at an angle of 0° or 90°.

5. The tool according to claim 1, wherein the key disk is set up to be positively joined in a torque-proof manner with the end caps.

6. The tool according to claim 5, wherein the edge side of the key disk exhibits at least eight equidistant recesses, which can be made to engage with elements protruding from the end cap.

7. The tool according to claim 1, wherein the key disk has the same radius as a contact surface of the circular end cap.

8. The tool according to claim 1, wherein the coupling is joined in a torque-proof manner with the key disk via three retaining bolts, and the lever exhibits a plug attachment to be joined in a torque-proof manner with the key disk.

9. The tool according to claim 1, wherein the lever, the coupling and the key disk exhibit boreholes that are aligned with each other, so that a safety bolt can be inserted in order to captively secure the lever to the key disk.

10. A tool for fastening and detaching an end cap of a water tank of an airplane, comprising,
a key disk,
a coupling,
a receptacle; and
a torque wrench having a plug attachment,
wherein the coupling is joined in a torque-proof manner with the key disk, and the coupling exhibits a receptacle, which is designed in such a way that a plug attachment of a torque wrench can be positively introduced into it.

11. A tool for fastening and detaching an end cap of a water tank, comprising:
a key disk;
a coupling, and
a lever having first and second ends, wherein
the first end of the lever is joined in a torque proof manner with the key disk via the coupling;
the key disk can be joined in a torque-proof manner with the end cap;
the second end of the lever exhibits a key connector that can be joined with a torque wrench;
the length of the lever and the key connection are diminished so as not to be blocked by obstacles in the environment of the cap;
the key connection exhibits an offset; and
the key connection exhibits a continuous opening and is configured to engage the torque wrench from opposite sides.

12. The tool according to claim 11, wherein the key connection exhibits a continuous opening, and is set up to be joined with the torque wrench from two opposite sides.

13. The tool according to claim 12, wherein the key connection is set up to be joined with the torque wrench at an angle of 0° or 90°.

14. The tool according to claim 13, wherein the key disk is set up to be positively joined in a torque-proof manner with the end caps.

15. The tool according to claim 14, wherein the edge side of the key disk exhibits at least eight equidistant recesses, which can be made to engage with elements protruding from the end cap.

16. The tool according to claim 15, wherein the key disk has the same radius as a contact surface of the circular end cap.

17. The tool according to claim 16, wherein the coupling is joined in a torque-proof manner with the key disk via three retaining bolts, and the lever exhibits a plug attachment to be joined in a torque-proof manner with the key disk.

18. The tool according to claim 17, wherein the lever, the coupling and the key disk exhibit boreholes that are aligned with each other, so that a safety bolt can be inserted in order to captively secure the lever to the key disk.
